(19) United States
(12) Patent Application Publication
(10) Pub. No.: US 2016/0049626 A1
(43) Pub. Date: Feb. 18, 2016

(54) CELL BLOCK

(71) Applicant: SANYO ELECTRIC CO., LTD., Daito-shi, Osaka (JP)

(72) Inventors: SHUNSUKE YASUI, Osaka (JP); YUJI UEHARA, Hyogo (JP); TAKUYA TSUTSUMI, Hyogo (JP); TOMOHIKO YOKOYAMA, Osaka (JP); SHINYA MOTOKAWA, Osaka (JP)

(21) Appl. No.: 14/779,568

(22) PCT Filed: Mar. 13, 2014
(86) PCT No.: PCT/JP2014/001434

§ 371 Date: Sep. 24, 2015

(30) Foreign Application Priority Data
Mar. 29, 2013 (JP) 2013-073918

(51) Int. Cl. H01M 2/12

(52) U.S. Cl. CPC H01M 2/1229

(57) ABSTRACT

Battery block includes a plurality of cells having safety valve on the negative electrode side, positive electrode plate part provided to the positive electrode side of cells and negative electrode plate part provided to the negative electrode side of cells in order to connect cells in parallel, duct cover covering the negative electrode side of cells and constituting duct chamber for exhausting exhaust gas discharged from safety valve, and insulating case for housing cells inside thereof. Negative electrode plate part is an elastic electrode plate part in elastic contact with negative electrode terminal, and duct cover is integrated with negative electrode plate part while pressing negative electrode plate part against negative electrode terminal at a predetermined pressing pressure.

### TECHNICAL FIELD

The present invention relates to a cell block (battery block) including a plurality of cells connected to each other.

### BACKGROUND ART

In order to form a battery block by connecting a plurality of cells to each other, an interconnecting member, a case, and the like, in addition to a plurality of cells, are necessary, and it is desirable that they can be assembled and disassembled easily.

PTL 1 discloses a battery system including a plurality of cells positioned and interconnected without welding. The battery system disclosed herein includes a separator case having columnar portions and in which a plurality of cells are aligned, and contact-holding panels confronting electrodes of the cells on the upper and lower parts of the separator case, respectively. The contact-holding panels include a frame, a contact strip held by a hook provided to the frame, and blades that are in contact with the electrodes of the cells and provided to the contact strip. The blades are urged by a coil spring provided to the frame, and pressed against the electrodes. The contact-holding panels are fixed to the plurality of columnar portions of the separator case by screws, respectively.

### CITATION LIST

### Patent Literature

PTL 1: Japanese Unexamined Patent Application Publication (Translation of PCT Application) No. 2010-538435

### SUMMARY OF THE INVENTION

### Problems to be Solved by the Invention

It is desired that a battery block formed by connecting a plurality of cells to each other can be disassembled easily, so that the cells and other component elements can be recycled.

### Means for Dissolving Problems

A battery block in accordance with the present invention includes a plurality of cells, each having a safety valve, aligned in such a manner that a safety valve side is arranged to a first side along a longitudinal direction of the cells, where the safety valve side is a side having the safety valve; a positive electrode plate part provided at a positive electrode side of the cells and a negative electrode plate part provided at a negative electrode side of the cells in order to connect the plurality of cells in parallel; and a duct cover covering the safety valve side of the cells and constituting a duct chamber for exhausting exhaust gas discharged from the safety valve. The positive electrode plate part or the negative electrode plate part corresponding to the safety valve side is an elastic electrode plate part that is in elastic contact with a positive electrode or a negative electrode which is a safety-valve-side electrode corresponding to the safety valve side. The duct cover is integrated with the elastic electrode plate part while pressing the elastic electrode plate part against the safety-valve-side electrode at a predetermined pressing pressure, with attractive force for attracting the duct cover and the elastic electrode plate part to each other.

### Advantages of the Invention

According to the present invention, a battery block can be easily disassembled by removing attractive force, and the cells and other component elements can be recycled.

### BRIEF DESCRIPTION OF THE DRAWINGS

FIG. 1 is a view showing an example of a battery block in accordance with an exemplary embodiment of the present invention.

FIG. 2 is a perspective view of a cell assembly constituting the battery block of FIG. 1.

FIG. 3 is an exploded view of the cell assembly of FIG. 2.

FIG. 4 is a sectional view of an example of the battery block in accordance with the exemplary embodiment of the present invention.

FIG. 5 is an enlarged exploded view of a negative electrode side of FIG. 4.

FIG. 6 is an enlarged exploded view of a positive electrode side of FIG. 4.

FIG. 7 is a view showing another configuration of an example of the battery block in accordance with the exemplary embodiment of the present invention.

FIG. 8 is a view showing an example of integration of an example of the cell assembly of the battery block in accordance with the exemplary embodiment of the present invention.

FIG. 9 is a detailed view of FIG. 8.

FIG. 10 is a view showing another example of integration of the cell assembly of the battery block in accordance with the exemplary embodiment of the present invention.

FIG. 11 is a detailed view of FIG. 10.

FIG. 12 is a view showing an example of a pressing member of the battery block in accordance with the exemplary embodiment of the present invention.

FIG. 13 is a view showing another example of a pressing member of the battery block in accordance with the exemplary embodiment of the present invention.

FIG. 14 is a top view of an arrangement container in accordance with a modified example of the exemplary embodiment of the present invention.

### DESCRIPTION OF EMBODIMENTS

Hereinafter, exemplary embodiments of the present invention are described in more detail. The following material, dimension, shape and number of cells, and the like, are mere examples and may be appropriately modified depending upon the specifications of a battery block. Hereinafter, the same reference numerals are given to the corresponding components in all drawings, and description thereof is omitted.

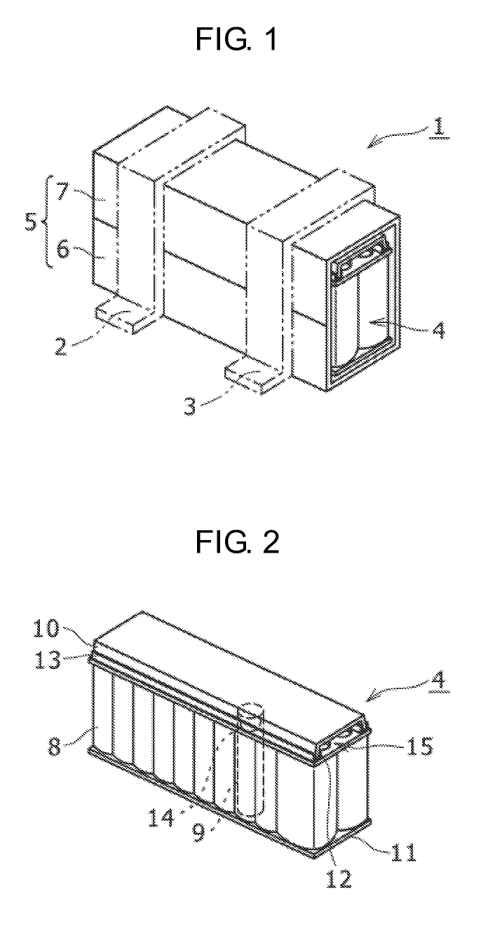

FIG. 1 is a view showing battery block 1. Battery block 1 includes a plurality of cells connected together, and is used as a power source having desired power capacity, for example, a unit of a storage battery device. Battery block 1 is fixed to, for example, an attachment plate to which a storage battery device is to be attached with attachment members 2 and 3 in a vehicle or the like. Battery block 1 is configured so as to be easily disassembled by removing attachment members 2 and 3. Thus, battery block 1 can be recycled. A component having failure or defectives can be replaced with a new one, and usable components can be used again.

Battery block 1 houses cell assembly 4 inside insulating case 5. Battery block 1 can be made attachable to, for example, an attachment plate for attaching a storage battery device (not shown), by using attachment members 2 and 3.

Attachment members 2 and 3 are not component elements of battery block 1, but they are members disposed along the outer periphery of insulating case 5, and attached to an attachment plate for attaching a storage battery device (not shown) by an appropriate fastening member. Thus, attachment members 2 and 3 press and integrate cells so that the cells of battery block 1 are not separated from each other. In other words, by removing attachment members 2 and 3 from battery block 1, battery block 1 can be disassembled easily. Examples of such attachment members 2 and 3 include bending plate material that has been processed from appropriate metallic material into a predetermined shape. Examples of the fastening member include a bolt, a screw, and the like.

Insulating case 5 is a case made of electrically insulating material and housing cell assembly 4 inside thereof. Insulating case 5 is made by combining lower case 6 and upper case 7 with each other. Therefore, when upper case 7 is taken off from lower case 6, cell assembly 4 can be taken out easily. Insulating case 5 is configured to integrate component elements of cell assembly 4 together and to electrically isolate a conductive part including cell assembly 4 and positive and negative electrode parts thereof from the outside. As such an insulating case 5, a case formed by molding plastic material having heat resistance property and electric insulation property into a predetermined shape can be used. Examples of the plastic material include polyethylene terephthalate, polyimide, polysulfone, polyether sulfone, polyetherimide, polyphenylene sulfide, polyether ether ketone, polycarbonate, modified polyphenylene ether, polybutylene terephthalate, and the like.

FIG. 2 is a perspective view of cell assembly 4 taken out from insulating case 5 of battery block 1. Cell assembly 4 includes a plurality of cells 9 housed in arrangement container 8, and duct cover 10. Positive electrode plate part 11 is provided at a positive electrode side of cells 9, and negative electrode plate part 12 is provided at a negative electrode side of cells 9. Insulating holding part 13 is provided between negative electrode plate part 12 and duct cover 10. Duct chamber 15 is formed between duct cover 10 and negative electrode plate part 12. Duct chamber 15 guides gas to the outside when the gas is discharged via safety valve 14 provided to cell 9, as mentioned later.

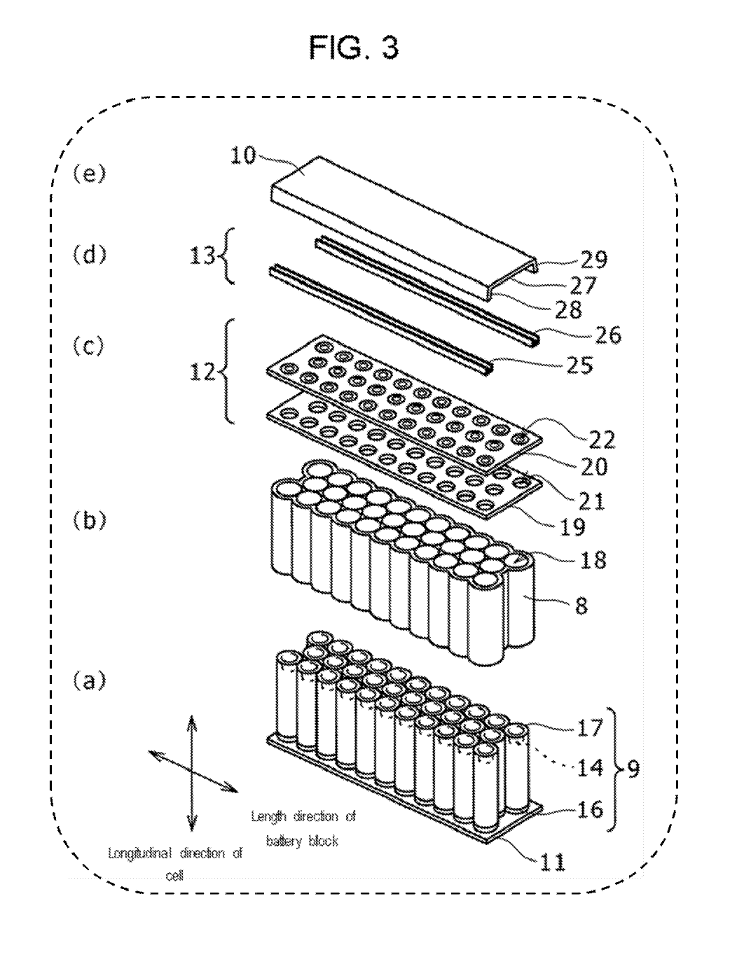

FIG. 3 is an exploded view of cell assembly 4. In cell assembly 4, cells 9 are integrated with positive electrode plate part 11 by, for example, welding. However, other components, that is, arrangement container 8, negative electrode plate part 12, insulating holding part 13, and duct cover 10 are not fixed to each other. Therefore, when attachment members 2 and 3 described in FIG. 1 attach battery block 1 to an attachment plate, attractive force for attracting duct cover 10 and negative electrode plate part 12 confronting duct cover 10 to each other is generated. This attractive force allows duct cover 10 and negative electrode plate part 12 to be integrated with each other. Then, the attractive force for attracting duct cover 10 and negative electrode plate part 12 confronting duct cover 10 to each other is removed when attachment members 2 and 3 are removed from the attachment plate. Thus, the component elements can be separated and disassembled from each other easily.

As shown in FIG. 3(a), each cell 9 is a chargeable-dischargeable secondary cell. In an example of FIG. 3, battery block 1 includes thirty-two cells 9 in total, and cells 9 are disposed in three rows. In each row, eleven or ten cells are disposed. The direction in which eleven or ten cells 9 are disposed is the length direction of battery block 1 and cell assembly 4. The thirty-two cells 9 are connected to each other in parallel by positive electrode plate part 11 and negative electrode plate part 12. Capacity of thirty-two cells 9 is 32 times as large as capacity of each of thirty-two cells 9. That is to say, battery block 1 is an assembled battery having capacity that is 32 times as large as capacity of one cell.

As the secondary cell, a lithium ion cell is used. In addition to this, a nickel metal-hydride cell, an alkaline cell, or the like, may be used. Cell 9 has a cylindrical outer shape. One of the both ends of the cylindrical cell is used as positive electrode terminal 16 and the other end is used as negative electrode terminal 17. One example of each cell 9 is a lithium ion cell having a diameter of 18 mm, height of 65 mm, a voltage between terminals of 3.6 V, and capacity of 2.5 Ah. This is an example for description, and cell 9 may have any other shapes, dimensions, and property values. For example, cell 9 may be a rectangular cell.

Each of cells 9 includes safety valve 14. Safety valve 14 is a mechanism for releasing gas as exhaust gas from the inside of cell 9 to the outside when a pressure of gas generated by electrochemical reaction occurring inside cell 9 exceeds a predetermined threshold pressure. Safety valve 14 is disposed at the negative electrode side of cell 9.

When a side having safety valve 14 is defined as a safety valve side, cells 9 are aligned in such a manner that the safety valve side is arranged to one side along the longitudinal direction of cells 9. The one side is a direction in which duct cover 10 of cell assembly 4 is provided.

The reason why the safety valve sides are arranged to the side provided with duct cover 10 in this way is because exhaust gas is discharged to the outside of battery block 1 through duct chamber 15 formed by duct cover 10 when the exhaust gas is discharged from safety valve 14. In this case, since safety valve 14 is provided at the negative electrode side of each cell 9, the negative electrode sides of cells 9 are arranged to one side that is the direction in which duct cover 10 is provided. Therefore, negative electrode terminal 17 of cell 9 is a safety-valve-side electrode. In the case of a cell provided with safety valve 14 at a positive electrode side, the positive electrode sides of cells 9 are arranged to the one side that is the direction in which duct cover 10 is disposed. At such a time, positive electrode terminal 16 is a safety-valve-side electrode.

Positive electrode plate part 11 is a member for connecting thirty-two cells 9 to each other in parallel. A detailed configuration of positive electrode plate part 11 is described later.

Arrangement container 8 shown in FIG. 3(b) is a holding container for holding cells 9 such that they are aligned in a predetermined lay-out relation. Arrangement container 8 is a framework body opening on both ends in the height direction and having thirty-two cell-containing portions 18. Each cell 9 is housed and disposed in one of cell-containing portions 18. Cell-containing portions 18 are disposed in a staggered (zigzag) arrangement in which each space between neighboring cells 9 is minimized. Examples of such arrangement container 8 include a container formed by molding plastic material into a predetermined shape. Instead of this, for example, containers formed by molding aluminum material as main material into a predetermined shape by extrusion molding or die-cast can be used.

Negative electrode plate part 12 is a member for connecting negative electrode terminals 17 of thirty-two cells 9 to each other in parallel. As shown in FIG. 3(c), negative electrode plate part 12 is formed by laminating two components, that is, insulating plate 19 and negative-electrode-side current collector plate 20. Negative-electrode-side current collector plate 20 has appropriate strength and thickness, and has elastic annular parts 22 molded by, for example, press-molding toward negative electrode terminals 17 of cells 9. Elastic annular parts 22 have appropriate elastic force. This elastic force brings negative electrode plate part 12 into elastic contact with negative electrode terminals 17 as electrodes at safety valve side of cells 9. Therefore, negative electrode plate part 12 is an elastic electrode plate part in cell assembly 4. Pressing force for elastic contact is given by attractive force for attracting duct cover 10 and negative electrode plate part 12 confronting duct cover 10 to each other.

Insulating plate 19 has openings 21 in positions corresponding to negative electrode terminals 17 that are safety-valve-side electrodes of thirty-two cells 9. Insulating plate 19 electrically insulates thirty-two cells 9 from each other. Examples of such insulating plate 19 include a plate made of glass-fiber-containing epoxy resin plate material having openings 21. Instead of glass-fiber-containing epoxy resin, the same material as that of insulating case 5 may be used.

Negative-electrode-side current collector plate 20 is disposed on the upper surface of insulating plate 19 and is made of conductive plate material having thirty-two elastic annular parts 22. Thirty-two elastic annular parts 22 are respectively brought into elastic contact with negative electrode terminals 17 as safety-valve-side electrodes of thirty-two cells 9 through openings 21 of insulating plate 19. The upper surface of insulating plate 19 is a surface facing duct cover 10.

In a plate-like negative-electrode-side current collector plate 20, elastic annular parts 22 are provided such that a portion corresponding to each of openings 21 of insulating plate 19 is projected toward insulating plate 19 by press-molding so as to open the middle thereof. The projected amount is set such that when elastic annular part 22 is brought into contact with negative electrode terminal 17 of cells 9, contact resistance therebetween is in a predetermined range. Managing the contact resistance in a predetermined range can be carried out by, for example, managing whether or not the pressing force given to negative electrode terminal 17 falls within a predetermined pressing force range when elastic annular part 22 is pressed to negative electrode terminal 17 by elasticity.

The lower limit of the range of the pressing force can be pressing force when contact resistance between negative-electrode-side current collector plate 20 and negative electrode terminal 17 is a predetermined threshold value of the contact resistance. The upper limit can be pressing force when stress occurring in elastic annular part 22 becomes elastic critical stress. The thickness as that elastic annular part 22 is substantially the same thickness as that of negative-electrode-side current collector plate 20. An example of the thickness of negative-electrode-side current collector plate 20 is about 1 mm to about 2 mm. Therefore, elastic annular part 22 can generate appropriate elastic force, that is, pressing force with respect to negative electrode terminal 17.

Examples of such a negative-electrode-side current collector plate 20 include a metal plate that has been processed into a predetermined shape and provided with elastic annular parts 22. Examples of material of the metal plate include phosphor bronze, stainless steel, nickel, nickel-iron alloy, copper, aluminum, or the like. If necessary, it is preferable that a part of elastic annular part 22 is coated with conductive grease or the like. Elastic annular part 22 may be, for example, gold-plated.

Since negative-electrode-side current collector plate 20 is provided with a plurality of elastic annular parts 22, it has a function of electrically connecting these elastic annular parts 22 in parallel and collecting current.

Insulating holding part 13 is a member for securing electrical insulation between negative-electrode-side current collector plate 20 of negative electrode plate part 12 and duct cover 10. As shown in FIG. 3(d), as insulating holding part 13, two insulation rails 25 and 26 are provided to correspond to leg parts 28 and 29 at both ends of duct cover 10. Insulation rails 25 and 26 are provided with grooves into which tip ends of leg parts 28 and 29 of both sides of duct cover 10 are fitted.

Duct cover 10 is a component covering the safety valve side of cell assembly 4 and forming duct chamber 15. Duct chamber 15 allows exhaust gas to flow along the end portion at the negative electrode side of cell assembly 4. Duct cover 10 includes ceiling part 27 and leg parts 28 and 29 extending downward from the both sides of ceiling part 27, and has a rectangular U-shape or a C-shape that opens downward. Use of duct chamber 15 enables exhaust gas discharged from safety valve 14 to be discharged from a predetermined exhaust hole to the outside of battery block 1 through duct chamber 15 without being leaked to other places. As such a duct cover 10, a cover, which has been processed from metal or other material having predetermined heat resistance and strength into a predetermined shape, can be used.

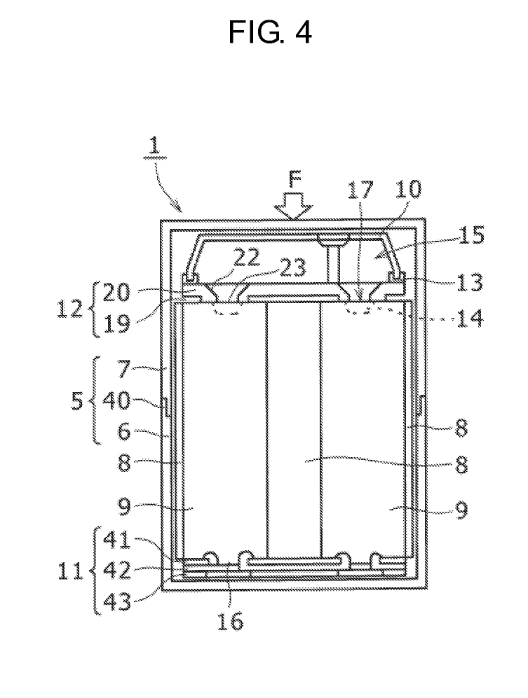

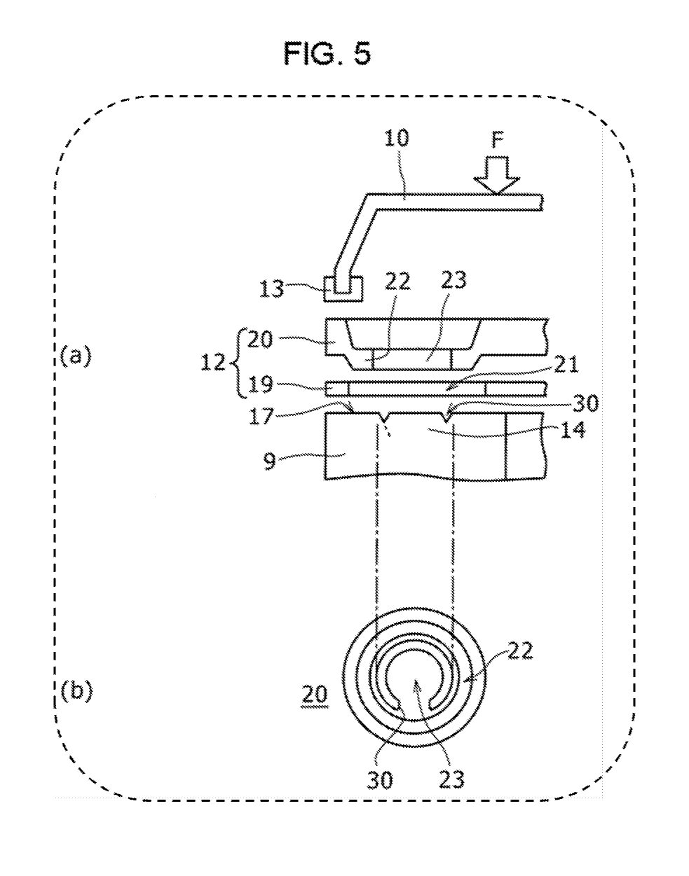

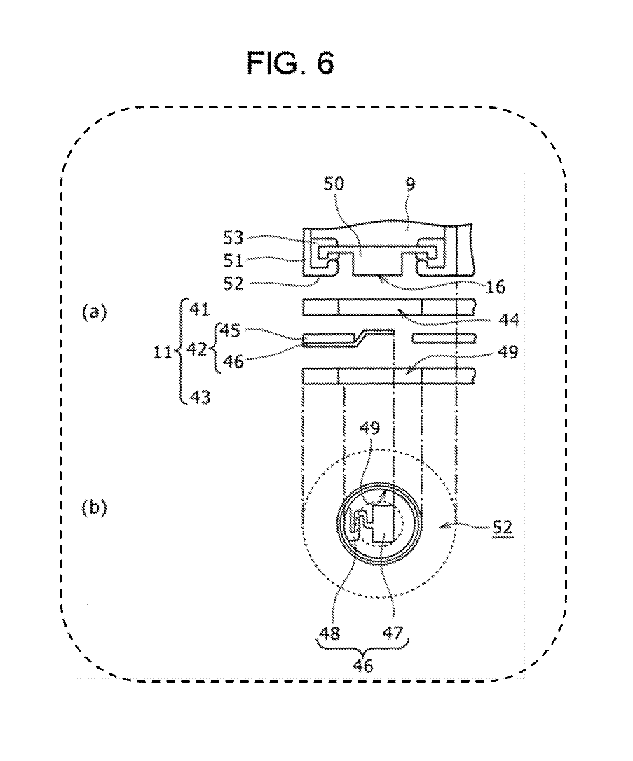

Next, pressing force given by negative electrode plate part 12 as an elastic electrode plate part to negative electrode terminal 17 in battery block 1 is described with reference to FIGS. 4 to 6. FIG. 4 is a sectional view taken on a plane perpendicular to the length direction of battery block 1. FIG. 5 is an enlarged exploded view of each component at the negative electrode side. FIG. 6 is an enlarged exploded view of component elements at the positive electrode side.

As shown in FIG. 4, insulating case 5 includes lower case 6 holding a cell 9 side, and upper case 7 holding a duct cover 10 side. Lower case 6 and upper case 7 are combined together at combining part 40, so that the airtightness of insulating case 5 is kept. In insulating case 5, fixing power is given between lower case 6 and upper case 7 when battery block 1 is fixed by attachment members 2 and 3 described in FIG. 1. The fixing power is applied to combining part 40. In FIG. 4, fixing power F is given to upper case 7 based on lower case 6. In this way, fixing power F is given to battery block 1 by attachment members 2 and 3. Note here that combining part 40 functions as cushioning material to prevent lower case 6 and upper case 7 from being broken by fixing power F given to battery block 1.

FIG. 4 shows two cells 9 seen in a cross section perpendicular to the length direction when cells are arranged in a staggered arrangement. Negative electrode plate part 12 is disposed at the negative electrode side of cells 9, and positive electrode plate part 11 is disposed at the positive electrode side of cells 9. Fixing power F is given such that it is dispersed as pressing force f by which each of elastic annular parts 22 in negative electrode plate part 12 presses each of negative electrode terminals 17. The state is described with reference to FIGS. 5 and 6.

FIG. 5 is an enlarged exploded view showing duct cover 10 and component elements at the parts of the negative electrodes of one cell 9. FIG. 5(a) is a sectional view and FIG. 5(b) is a view of the negative electrode side of cell 9 seen from a negative-electrode-side current collector plate 20 side.

As shown in FIG. 5(a), fixing power F given to battery block 1 is given to duct cover 10 via upper case 7. Fixing power F functions as integrating component elements of battery block 1 so that the component elements are not separated from each other. In addition, fixing power F functions as keeping air-tightness between duct cover 10 and negative electrode plate part 12 so that exhaust gas flows into duct chamber 15 without being leaked to other places.

Furthermore, fixing power F generates attractive force for attracting duct cover 10 and negative electrode plate part 12 confronting duct cover 10 to each other. With this attractive force, duct cover 10 is integrated with the elastic electrode plate part while pressing negative electrode plate part 12 as the elastic electrode plate part against negative electrode terminal 17 as the safety-valve-side electrode with predetermined pressing pressure. That is to say, duct cover 10 presses negative electrode plate part 12 toward negative electrode terminals 17 of cells 9 via insulating holding part 13. Negative electrode plate part 12 is a laminated body of insulating plate 19 and negative-electrode-side current collector plate 20. From the bottom surface of the laminated body, thirty-two elastic annular parts 22 protrude. Therefore, fixing power F is given as dispersion force, that is, pressing force f by which each of thirty-two elastic annular parts 22 presses negative electrode terminal 17. Pressing force f has magnitude of F/32 according to calculation, but individual pressing force f of each elastic annular part 22 is not F/32 due to, for example, variations of thirty-two elastic annular parts 22. With the variations of thirty-two elastic annular parts 22 or the like taken into account, pressing force f of each of elastic annular parts 22 is set such that the contact resistance between negative-electrode-side current collector plate 20 and negative electrode terminal 17 becomes a predetermined threshold value or less.

An opening in the middle of elastic annular part 22 shown in FIG. 5(a) is a discharge hole for discharging exhaust gas from safety valve 14 to the duct cover 10 side. Recess 30 provided to negative electrode terminal 17 of cell 9 and shown in a horseshoe-shape in FIG. 5(b) is a thin part in safety valve 14. The thin portion is broken when a pressure of gas generated by electrochemical reaction occurring inside cell 9 exceeds a predetermined threshold pressure, recess 30 is opened, and exhaust gas from the inside of cell 9 is released. Elastic annular part 22 of negative-electrode-side current collector plate 20 is brought into contact with negative electrode terminal 17 of cell 9 at the outer peripheral side with respect to recess 30. Since the outer peripheral side with respect to recess 30 has a considerably large area, a sufficient contact area between elastic annular part 22 and negative electrode terminal 17 can be obtained.

Similar to negative electrode plate part 12, positive electrode plate part 11 is a member for connecting negative electrode terminals 17 of thirty-two cells to each other in parallel. As shown in FIG. 4, positive electrode plate part 11 is formed by laminating three components, that is, insulating plate 41, positive electrode contact plate 42, and positive-electrode-side current-collector plate 43. FIG. 6 is an enlarged exploded view showing component elements of positive electrode plate part 11 and the positive electrode of one cell 9. FIG. 6(a) is a sectional view and FIG. 6(b) is a view of the positive electrode side of cell 9 seen from a positive-electrode-side current-collector plate 43 side.

Sealing plate 50 is disposed on the positive electrode side of cells 9. Sealing plate 50 is connected to each of the positive electrodes inside cells 9 and has positive potential of cell 9. Opening edge portion 52 of battery can 51 having negative potential of cell 9 is pressed and bent. Sealing plate 50 is fixed to battery can 51 by gasket 53 as insulating material. The middle part of sealing plate 50 is protrusion-shaped positive electrode terminal 16. In this way, in the positive electrode side of cell 9, the middle part of sealing plate 50 protrudes as positive electrode terminal 16, and the surrounding thereof is surrounded by opening edge part 52 which is pressed and bent portion of battery can 51 insulated by gasket 53. Opening edge portion 52 of battery can 51 corresponds to the case of cell 9, and has a firm strength.

Insulating plate 41 of positive electrode plate part 11 is insulating plate material similar to insulating plate 19 used for negative electrode plate part 12. Insulating plate 41 is provided with openings 44 at positions corresponding to positive electrode terminals 16 of thirty-two cells 9, respectively. As such insulating plate 41, insulating material, which is the same material as that of insulating plate 19 of the negative electrode side and is molded in a predetermined shape, can be used.

Positive electrode contact plate 42 is a flexible circuit board in which conductive wiring 46 is disposed on flexible resin sheet 45. As shown in (b), conductive wiring 46 includes positive electrode contact part 47 and fuse 48 from which resin sheet 45 has been removed, and is electrically connected to positive-electrode-side current-collector plate 43.

Positive electrode contact part 47 is bent so as to protrude from resin sheet 45 toward the positive electrode terminal 16 side. Positive electrode contact part 47 can pass through opening 44 in insulating plate 41 and be brought into contact with positive electrode terminal 16, and is connected and fixed to positive electrode terminal 16 by, for example, welding. Fuse 48 is a safety device obtained by forming conductive wiring 46 into a narrow and long shape and has a moderately high resistance value. Fuse 48 is melted and cut when an excessive amount of electric current flows therein. Examples of such positive electrode contact part 47 include a polyimide resin sheet on which a copper foil is wired.

Positive-electrode-side current-collector plate 43 is conductive plate material provided with appropriate opening 49 at a position corresponding to a position in which positive electrode contact part 47 of positive electrode contact plate 42 and fuse 48 are disposed. Presence of providing of opening 49 can prevent fuse 48 from being brought into contact with and short-circuited to positive-electrode-side current-collector plate 43. Furthermore, positive-electrode-side current-collector plate 43 is electrically connected to thirty-two positive electrode contact parts 47 via fuse 48, and positive electrode contact parts 47 are connected to corresponding positive electrode terminals 16 by, for example, welding. Accordingly, positive electrode contact parts 47 have a function of electrically connecting positive electrode sides of thirty-two cells 9 in parallel and collecting current. As such positive-electrode-side current-collector plate 43, a plate formed by molding a metal conductive plate having an appropriate thickness into a predetermined shape can be used. Examples of the metal material include aluminum, copper, nickel, and an ally of iron and nickel.

As shown in FIG. 6(b), opening edge portion 52 of battery can 51 at the positive electrode of cell 9 corresponds to a position at the outer side with respect to opening 44 of insulating plate 41, a position at the outer side with respect to the position at which positive electrode contact part 47 of positive electrode contact plate 42 and fuse 48 are disposed, and a position at the outer side with respect to opening 49 of positive-electrode-side current-collector plate 43. When duct cover 10 receives fixing power F at the negative electrode side of cell 9, insulating plate 41, positive electrode contact plate 42 and positive-electrode-side current-collector plate 43 receive opening edge portion 52 of battery can 51 at the positive electrode side. The receiving position is a position at the outer side of openings 44 and 49. As mentioned above, since opening edge portion 52 of battery can 51 has a firm strength, when insulating plate 41 and positive-electrode-side current-collector plate 43 have sufficient thicknesses, fixing power F can be received at the positive electrode side.

Thus, fixing power F is given to insulating case 5 by attachment members 2 and 3, and fixing power F fixes duct cover 10 to the inside of insulating case 5. Fixing power F generates attractive force for attracting duct cover 10 to negative electrode plate part 12 confronting duct cover 10. The attractive force allows duct cover 10 to be integrated with negative-electrode-side current collector plate 20. Then, with fixing power F, duct cover 10 presses elastic annular part 22 as the elastic electrode plate part of negative electrode plate part 12 to negative electrode terminal 17 as the safety-valve-side electrode with pressing force f exceeding a predetermined threshold pressing pressure. This ensures electrical conduction between negative electrode terminals 17 of cells 9 and negative electrode plate part 12.

Then, when attachment members 2 and 3 are taken off from the attachment plate, the attractive force for attracting duct cover 10 and negative electrode plate part 12 confronting duct cover 10 is removed.

Accordingly, the component elements can be easily separated from each other and disassembled. That is to say, insulating case 5 is divided into lower case 6 and upper case 7, and cell assembly 4 can be taken out from lower case 6. In this state, since duct cover 10 is not fixed to insulating case 5, duct cover 10, negative-electrode-side current collector plate 20 constituting negative electrode plate part 12, and insulating plate 19 can be disassembled sequentially. When arrangement container 8 is taken off, thirty-two cells 9 fixed to positive electrode plate part 11 appear downward from cell-containing portion 18 of arrangement container 8.

Furthermore, positive electrode terminal 16 of cell 9 is connected and fixed to positive electrode contact part 47 via fuse 48 by, for example, welding.

By cutting fuse 48 by an external pressure, thirty-two cells 9 fixed to positive electrode plate part 11 can be separated from positive electrode plate part 11. In order to cut fuse 48 by an external pressure, it is preferable that fuse 48 has such strength that can be cut by a cutter or the like, and such tensile strength that can be cut when positive electrode plate part 11 and cell 9 are drawn in the opposite directions.

In this way, by removing attachment members 2 and 3, and removing the fixture of duct cover 10 by insulating case 5, battery block 1 can be easily disassembled into each component element.

In the above configuration, with fixing power F for attaching battery block 1 to the attachment plate, duct cover 10 is integrated with negative electrode plate part 12 while pressing negative electrode plate part 12 as the elastic electrode plate part against negative electrode terminal 17 as the safety-valve-side electrode at a predetermined pressing pressure. Instead, a duct cover and an insulating case can be integrated with each other by using a fixing member, and, with tightening force thereof, duct cover 10 can be integrated with negative electrode plate part 12, while pressing negative electrode plate part 12 against negative electrode terminal 17 at a predetermined pressing pressure.

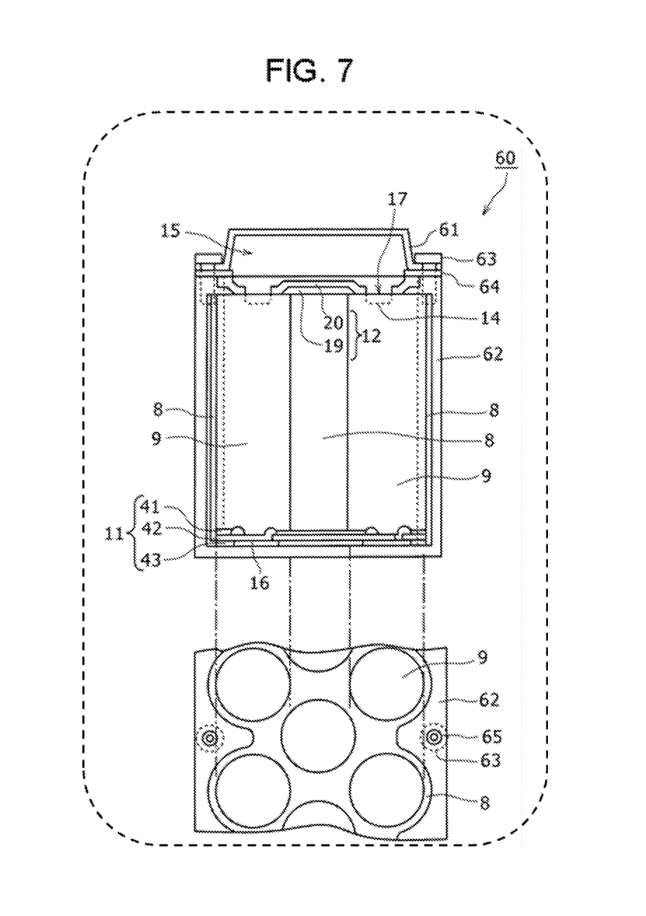

Battery block 60 shown in FIG. 7 is an example in which duct cover 61 and insulating case 62 are directly connected to each other by fixing screws 63. FIG. 7 is a sectional view corresponding to FIG. 4. Herein, attractive force for attracting duct cover 61 and negative electrode plate part 12 that is an elastic electrode plate part to each other is given by fastening force of fixing screw 63.

Duct cover 61 is provided with flange portions at the both sides in the width direction in order to attach fixing screws 63. Insulating case 62 is a pipe-shaped member having a bottom and opening at a duct cover 61 side.

In insulating case 62, upper case 7 shown in FIG. 4 is omitted. The depth thereof is set so as to house cell 9, negative electrode plate part 12 and positive electrode plate part 11. The upper surface of insulating case 62 is provided with screw holes 65 corresponding to fixing screws 63. Insulating member 64 provided between duct cover 61 and negative electrode plate part 12 is used so as to secure insulation between duct cover 61 and negative electrode plate part 12 similar to insulating holding part 13 of FIG. 4.

In the above configuration, the attractive force for attracting duct cover 61 and negative electrode plate part 12 as the elastic electrode plate part to each other is given via insulating cases 5 and 62. However, the attractive force for attracting duct cover 61 and negative electrode plate part 12 as the elastic electrode plate part to each other may be given only by cell assembly 4.

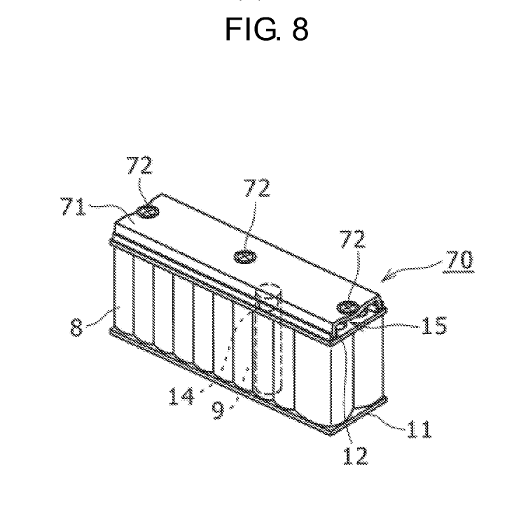

FIG. 8 is a view of cell assembly 70, showing an example in which duct cover 71 and positive electrode plate part 11 are fixed by integrating means. FIG. 8 shows cover-side attachment screw 72 provided to duct cover 71 as the integrating means.

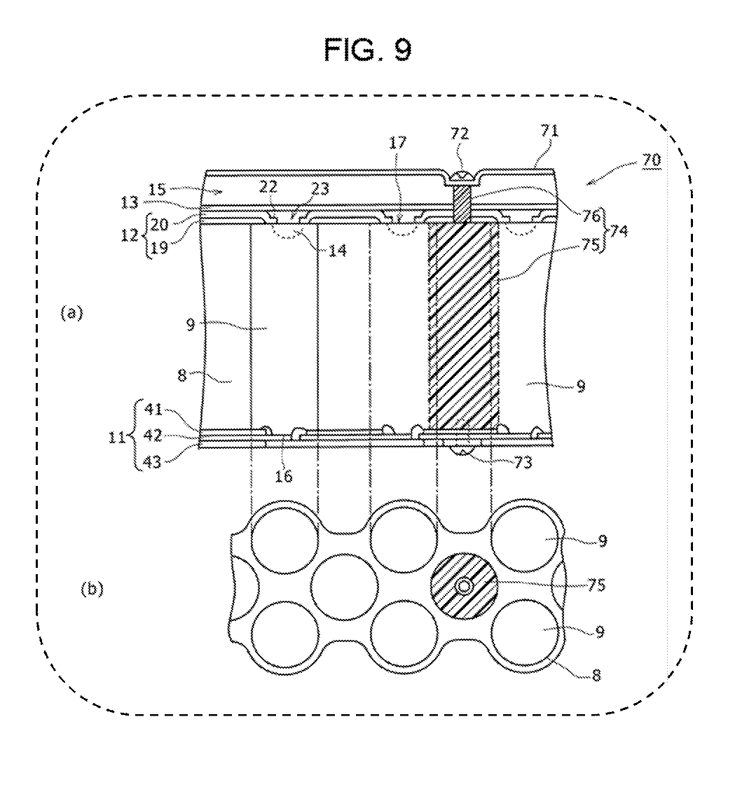

FIG. 9 is a detailed view of cell assembly 70, and (a) is a sectional view and (b) is a bottom view showing cell 9 and arrangement container 8 seen from the positive electrode plate part 11 side by taking off positive electrode plate part 11. The integrating means includes insulating columnar portion 74, cover-side attachment screw 72, and positive-electrode-plate-side attachment screw 73. Cover-side attachment screw 72 is first integrating means, and positive-electrode-plate-side attachment screw 73 is second integrating means.

Insulating columnar portion 74 is insulating material constituting the integrating means and being disposed between positive electrode plate part 11 as a rear-side electrode part and duct cover 71. Insulating columnar portion 74 is provided so as to secure insulation when duct cover 71 and positive electrode plate part 11 are integrated with each other. Insulating columnar portion 74 includes first columnar portions 75 replaced with some of the plurality of cells 9 housed in arrangement container 8 and second columnar portion 76 integrated with first columnar portions 75 and extending toward duct cover 71. Positive electrode plate part 11 side of first columnar portion 75 is provided with a screw hole corresponding to positive-electrode-plate-side attachment screw 73. Duct cover 71 side of second columnar portion 76 is provided with a screw hole corresponding to cover-side attachment screw 72.

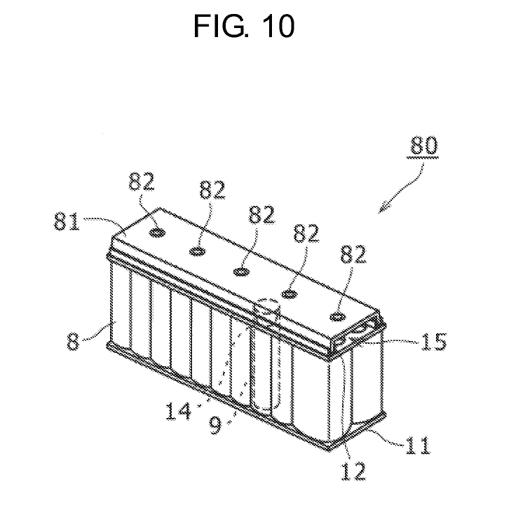

FIGS. 8 and 9 use insulating columnar portion 74 and an attachment screw as the integrating means. In this method, the total number of cells 9 constituting cell assembly 70 becomes smaller by the number of insulating columnar portions 74. FIG. 10 is a view of cell assembly 80, showing an example in which integrating means for integrating duct cover 81 and positive electrode plate part 11 to each other is a rivet that is allowed to pass through arrangement container 8. FIG. 10 shows cover-side head portions 82 of the rivet located at duct cover 81 side.

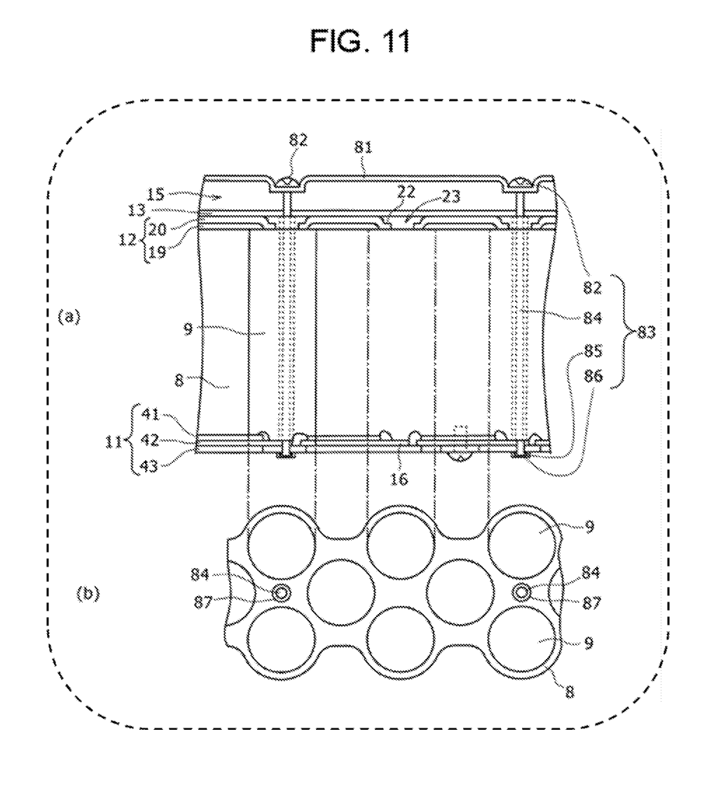

FIG. 11 is a detailed view of cell assembly 80, and (a) is a sectional view and (b) is a bottom view showing cells 9 and arrangement container 8 seen from positive electrode plate part 11 side by taking off positive electrode plate part 11. Integrating means is rivet 83.

Rivet 83 includes rivet main body 84, cover-side head portion 82, positive-electrode-side head portion 85 at the positive electrode plate side, and insulating part 86 for covering positive-electrode-side head portion 85. Insulating part 86 is used to secure insulation along with insulating holding part 13 when duct cover 81 and positive electrode plate part 11 are integrated with each other. Rivet main body 84 is provided not to a position of the cell-containing portion that is an opening for housing cells 9 in arrangement container 8, but to a portion including material constituting arrangement container 8. Through-hole 87 through which rivet main body 84 is allowed to pass is provided. As such a rivet 83, a rivet called a blind rivet, which is capable of rivet operation on one side of positive electrode plate part 11 side or the duct cover 81 side, can be used.

The rivet operation can be carried out as follows. Rivet material before the rivet operation is thin wire material having a predetermined length and provided with a head portion at one end and a thin head counterpart before operation at the other end. The head counterpart is provided with an insulating cover as an insulating part in advance. This rivet material is disposed at the duct cover 81 side, for example, in a state in which the head portion is located at cover-side head portion 82. The head counterpart and a thin wire material part are allowed to pass through through-hole 87 of arrangement container 8, and the head counterpart is allowed to protrude at positive electrode plate part 11 side. The protruding head counterpart having the insulating cover is drawn by using a rivet operation tool, so that positive-electrode-side head portion 85 having insulating part 86 is formed. Thus, duct cover 81 and positive electrode plate part 11 are integrated with each other while insulation is secured.

When the attractive force for attracting the duct cover and negative electrode plate part 12 as the elastic electrode plate part to each other is insufficient, variation may occur in the electrical contact between negative electrode terminal 17 and negative electrode plate part 12 in the plurality of cells 9 depending on places. In order to suppress the variation, a pressing member for pressing lifting of the elastic electrode plate part may be provided between the duct cover and the upper surface of negative electrode plate part 12 as the elastic electrode plate part covered with the duct cover.

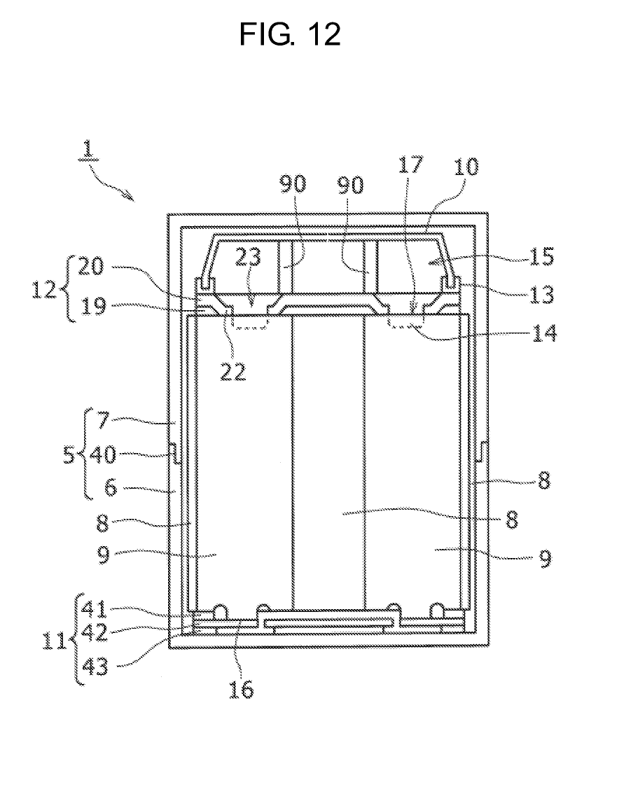

Battery block 1 shown in FIG. 12 is provided with a plurality of protruding bosses 90 as pressing members. Protruding bosses 90 protrude from duct cover 10 toward negative electrode plate part 12 as the elastic electrode plate part. Protruding bosses 90 can suppress lifting of negative electrode plate part 12. Examples of protruding boss 90 include a protruding boss formed by attaching an appropriate insulative stick member to duct cover 10 by fixing means such as a screw, and a protruding boss integrated with duct cover 10. When protruding boss 90 is integrated with duct cover 10, it is necessary to provide an insulating member at the tip end contacting negative electrode plate part 12 in protruding boss 90.

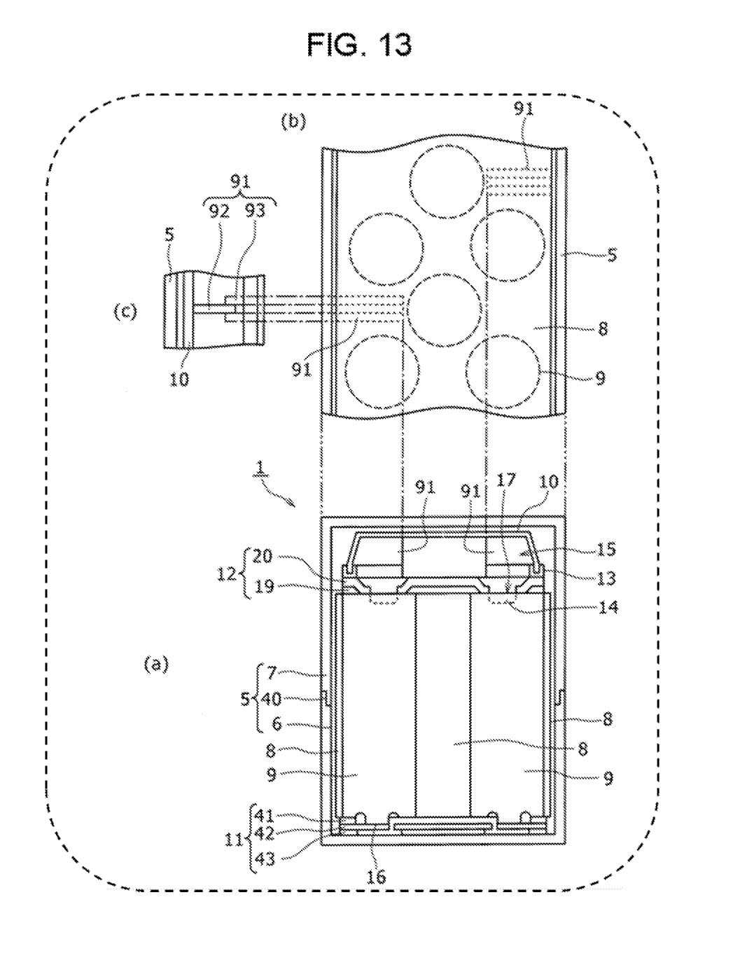

Battery block 1 shown in FIG. 13 is provided with ribs 91 as pressing members in a part of duct cover 10. FIG. 13(a) is a sectional view corresponding to FIG. 4. FIG. 13 (b) is a plan view seen from the top surface of duct cover 10 and insulating case 5 is omitted in this drawing. FIG. 13 (c) is a detailed sectional view of a part of rib 91.

Rib 91 partially extends in the width direction of duct cover 10, and is brought into contact with negative electrode plate part 12 on the bottom surface thereof. Rib 91 includes projected part 92 integrated with duct cover 10 and insulating member 93 provided on the bottom surface of projected part 92. Similar to insulating holding part 13, insulating member 93 is used to secure insulation between duct cover 10 and negative electrode plate part 12.

Note here that the pressing member is not necessarily limited to a member, such as projected part 92 of rib 91, integrated with duct cover 10. For example, insulating holding part 13 shown in FIG. 3 or insulating member 64 shown in FIG. 7 may be formed in a planar structure to cover the upper part of the negative electrode side of cell 9 like insulating plate 19 and columnar protrusions may be provided from the surface at cell 9 side toward duct cover 10. Also in a planar structure in which insulating holding part 13 shown in FIG. 3 or insulating member 64 shown in FIG. 7 cover the upper part of the negative electrode side of cell 9, opening is provided similar to opening 21 of insulating plate 19.

In the above configuration, in order to align cells 9, arrangement container 8 is used. However, arrangement container 8 may be occasionally omitted. A shape of the inner wall of insulating case 5 can be made so as to be suitable for aligning, so that a plurality of cells 9 is aligned by using the shape of the inner wall.

In the above configuration, safety valve 14 is provided in the vicinity of negative electrode terminals 17 of cells 9, and duct cover 10 is configured to press negative electrode plate part 12. When safety valve 14 is provided in the vicinity of positive electrode terminals 16 of cells 9, the structure of FIG. 5 is applied to the positive electrode side and the structure of FIG. 6 is applied to the negative electrode side. At this time, battery block 1 can be easily disassembled into the component elements thereof.

In the above configuration, insulating plates 19 and 41 are not necessarily limited to a plate shape. For example, insulating plates 19 and 41 may be provided with a holder part for holding a part of cells 9 or arrangement container 8.

In the above configuration, arrangement container 8 is a framework body provided with thirty-two cell-containing portions 18 opening at both end sides in the height direction. However, as long as a holding container which holds cells 9 in a state in which cells 9 are aligned in a predetermined arrangement relation, each of cell-containing portions 18 provided in arrangement container 8 is not necessarily a container for housing one cell.

By the way, battery block 1 is required to be small in size in order to increase the amount thereof to be mounted on a vehicle or to reduce space for a storage battery device.

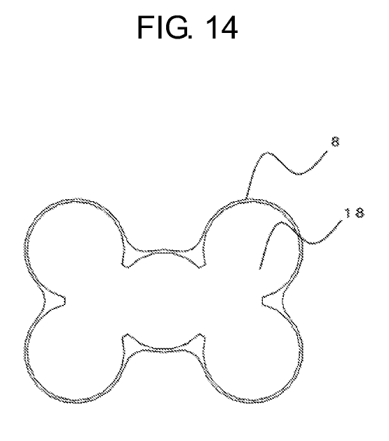

FIG. 14 is a top view of an arrangement container in accordance with a modified example of the exemplary embodiment of the present invention.

Cell-containing portion 18 of FIG. 14 accommodates five cells 9 (not shown) in one housing portion. Cell-containing portion 18 has side surfaces along the side surfaces of cells 9. Cell-containing portion 18 has side surfaces in contact with cells 9 and side surfaces not in contact with cells 9. The side surfaces not in contact with cells 9 are formed in a range of a region in which side surfaces of neighboring cells 9 confront each other. Rivet 83 (not shown) is inserted into a space formed on side surfaces not in contact with cells 9, so that rivet 83 prevents the neighboring cells 9 from being brought into contact with each other. Battery block 1 can integrate component elements of cell assembly 4 by inserting rivet 83 into a space formed on the side surface not in contact with cells 9 without providing through-holes 87. Furthermore, in battery block 1, when neighboring cells 9 share cell-containing portion 18 by providing side surfaces not in contact with cells 9 in cell-containing portion 18 without providing through-holes 87, a volume of arrangement container 8 can be reduced. Thus, the size of battery block 1 can be reduced.

### REFERENCE MARKS IN THE DRAWINGS

1, 60 battery block
2, 3 attachment member
4, 70, 80 cell assembly
5, 62 insulating case
6 lower case
7 upper case
8 arrangement container
9 cell
10, 61, 71, 81 duct cover
11 positive electrode plate part
12 negative electrode plate part
13 insulating holding part
14 safety valve
15 duct chamber
16 positive electrode terminal
17 negative electrode terminal
18 cell-containing portion
19, 41 insulating plate
20 negative-electrode-side current collector plate
21 opening
22 elastic annular part
25, 26 insulation rail
27 ceiling part
28, 29 leg part
30 recess
40 combining part
42 positive electrode contact plate
43 positive-electrode-side current-collector plate
44, 49 opening
45 resin sheet
46 conductive wiring
47 positive electrode contact part
48 fuse
50 sealing plate
51 battery can
52 opening edge portion
53 gasket
63 fixing screw
64, 93 insulating member
65 screw hole
72 cover-side attachment screw
73 positive-electrode-plate-side attachment screw
74 insulating columnar portion
75 first columnar portion
76 second columnar portion
82 cover-side head portion
83 rivet
84 rivet main body
85 positive-electrode-side head portion
86 insulating part
87 through hole
90 boss
91 rib
92 projected part

1. A battery block comprising:
a plurality of cells, each having a safety valve, aligned in such a manner that a safety valve side is arranged to a first side along a longitudinal direction of the cells, where the safety valve side is a side having the safety valve;
a positive electrode plate part provided at a positive electrode side of the cells and a negative electrode plate part provided at a negative electrode side of the cells in order to connect the plurality of cells in parallel; and
a duct cover covering the safety valve side of the cells and constituting a duct chamber for exhausting exhaust gas discharged from the safety valve,
wherein the positive electrode plate part or the negative electrode plate part corresponding to the safety valve side is an elastic electrode plate part that is in elastic contact with a positive electrode or a negative electrode which is a safety-valve-side electrode corresponding to the safety valve side, and
the duct cover is integrated with the elastic electrode plate part while pressing the elastic electrode plate part against the safety-valve-side electrode at a predetermined pressing pressure, with attractive force for attracting the duct cover and the elastic electrode plate part to each other.

2. The battery block of claim 1, wherein the duct cover is integrated with the elastic electrode plate part while pressing the elastic electrode plate part against the safety-valve-side electrode at a predetermined pressing pressure, by an attachment member for attaching the battery block to a battery block attaching plate.

3. The battery block of claim 1, further comprising an insulating case for housing at least the plurality of cells inside thereof, wherein the duct cover is integrated with the elastic electrode plate part while pressing the elastic electrode plate part against the safety-valve-side electrode at a predetermined pressing pressure, by a fixing member for fixing the duct cover to an upper surface of the insulating case.

4. The battery block of claim 1, wherein when the positive electrode plate part or the negative electrode plate part, which is disposed at an opposite side to the elastic electrode plate part, is defined as a rear-surface-side electrode part,
the duct cover is integrated with the elastic electrode plate part while pressing the elastic electrode plate part against the safety-valve-side electrode at a predetermined pressing pressure, by integrating means for integrating the duct cover and the rear-surface-side electrode part with each other.

5. The battery block of claim 4, wherein the integrating means includes:
an insulating columnar portion disposed between the rear-surface-side electrode part and the duct cover;
a first integrating means for fixing the duct cover to a first end of the insulating columnar portion; and
a second integrating means for fixing the rear-surface-side electrode part to a second end of the insulating columnar portion.

6. The battery block of claim 5, wherein the insulating columnar portion is disposed in place of any of the cells.

7. The battery block of claim 4, wherein the integrating means is a rivet having rivet head portions at both ends, and a rivet head portion of at least one end is an electrically insulating head portion.

8. The battery block of claim 1, wherein when the positive electrode plate part or the negative electrode plate part, which is disposed at an opposite side to the elastic electrode plate part, is defined as a rear-surface-side electrode part,
the rear-surface-side electrode part is electrically connected to a positive electrode or a negative electrode which is a counter electrode of the safety-valve-side electrode via a fuse that can be cut by an external pressure.

9. The battery block of claim 1, further comprising a pressing member for pressing lifting of the elastic electrode plate part between the duct cover and an upper surface of the elastic electrode plate part covered with the duct cover.

10. The battery block of claim 9, wherein the pressing member is a plurality of protruding members protruding from the duct cover toward the elastic electrode plate part.

11. The battery block of claim 10, wherein the plurality of protruding members is a plurality of protruding bosses attached to the duct cover.

12. The battery block of claim 10, wherein the plurality of protruding members is ribs provided to the duct cover.

13. The battery block of claim 9, wherein the pressing member includes an insulating member for insulating the elastic electrode plate part and the duct cover from each other.
